(19) United States
(12) Patent Application Publication
(10) Pub. No.: US 2024/0127292 A1
(43) Pub. Date: Apr. 18, 2024

(54) Artificially Intelligent Smart Campaigns

(71) Applicant: Bluecore, Inc., New York, NY (US)

(72) Inventors: Bryan Estes, Seattle, WA (US); Amber Victoria Tunnell, Brooklyn, NY (US); Stephen Papa, San Jose, CA (US); Max Solomon Bennett, Brooklyn, NY (US); Jennifer Wang Hou, Brooklyn, NY (US); Francesco Fraioli, Brooklyn, NY (US); Connie Chau, New York, NY (US); Bahar Bipin Shah, New York, NY (US); Zahi Nadim Karam, Brooklyn, NY (US)

(21) Appl. No.: 18/540,553

(22) Filed: Dec. 14, 2023

Related U.S. Application Data
(63) Continuation-in-part of application No. 15/930,349, filed on May 12, 2020, now Pat. No. 11,847,671.
(60) Provisional application No. 62/858,141, filed on Jun. 6, 2019.

(51) Int. Cl. G06Q 30/0251; G06F 16/9535

(52) U.S. Cl. CPC G06Q 30/0271; G06F 16/9535

(57) ABSTRACT

Provided herein are exemplary embodiments including a computer-implemented method of using artificial intelligence for automatically collecting and enriching network data for a smart campaign with autopilot features. The method includes, collecting a set of network data relevant to a smart campaign with autopilot features, applying one or more transformations to the collected set of data to create a modified set of data, generating from the modified set of data, enriched network data for a smart campaign with autopilot features, the enriched network data having content, context and event data, and using the enriched data to deploy a personalized campaign by identifying an audience, time, channel, content and goal of the communication.

### CROSS-REFERENCE TO RELATED APPLICATION

This continuation-in-part application claims the priority benefit of U.S. patent application Ser. No. 15/930,349 filed on May 12, 2020, which claims the benefit of U.S. Provisional Application No. 62/858,141 filed Jun. 6, 2019, all of which are hereby incorporated by reference in their entireties.

### FIELD

The present technology relates generally to communications and more specifically, to using artificial intelligence to automatically create a dynamically configured personalized communication for a campaign with autopilot features.

### SUMMARY

This summary is provided to introduce a selection of concepts in a simplified form that are further described in the Detailed Description below.

The exemplary systems and methods herein are constantly aware of more real-time content, context and/or relevant event data throughout the world than an army of humans would have the ability to appreciate, and employs AI to make sense of it all, including the most relevant audience, schedule, content and/or channel for delivery.

The exemplary systems and methods herein, with each permutation of content, context and/or relevant event data, determines the most relevant audience, schedule, content and/or channel for delivery that may differ from a previously determined audience, schedule, content and/or channel for delivery based on another permutation.

Exemplary embodiments include a computer-implemented method of using artificial intelligence for automatically collecting and enriching network data for a smart campaign with autopilot features. The method includes, collecting a set of network data relevant to a smart campaign with autopilot features, applying one or more transformations to the collected set of data to create a modified set of data, generating from the modified set of data, enriched network data for a smart campaign with autopilot features, the enriched network data having content, context and event data, and using the enriched data to deploy a personalized campaign by identifying an audience, time, channel, content and goal of a communication.

According to various exemplary embodiments, the collecting may include scraping a website, receiving data through a feed, data warehouse, input from a user, or from a database. Additionally, the artificial intelligence may apply one or more transformations to the collected set of data to create the modified set of data, including adding context to the collected set of data. The artificial intelligence may also apply one or more transformations to the collected set of data to create the modified set of data, including adding collected event information. The artificial intelligence may use the content, the context and the event information to identify who would be interested in the content, the context and the event information and automatically determine when to send the message.

The artificial intelligence, in various exemplary embodiments, may generate in the message a recommendation related to the enriched content and/or bias in the message a recommendation towards context. The artificial intelligence may also generate message copy related to the context and/or include in the message a promotion or a discount related to the context. The artificial intelligence may include in the message an originally scraped image or an AI composed image related to content or context. The artificial intelligence may generate and/or compose new content, copy or images based on the content scraped and the context extracted. Exemplary embodiments also include the artificial intelligence measuring performance of a message or a campaign of messages.

In various exemplary embodiments, the collected set of network data relevant to a smart campaign with autopilot features includes content, context, event data, retailers' websites including banners, hero images, coupons, discounts, promotions, how retailers' websites merchandising/site management team categorizes content, categories and/or products currently being promoted, upcoming promotions on categories or products, product-category combinations, weather forecasts, severe weather events, product information, sports teams, and/or themes. The artificial intelligence may constantly scrape and monitor a retailer's web site for new banners, images, coupons, discounts, or promotions and/or download the new banners, images, coupons, discounts, or promotions and enriching them with context and automatically use them in a campaign. The artificial intelligence may also constantly scrape and monitor a retailer's web site for how the retailer categorizes content and what categories and/or products that are currently being promoted.

The artificial intelligence, according to various exemplary embodiments, may enrich the content with context and/or enrich the scraped content with context, including a product or category description. The artificial intelligence may enrich the content with context, including adding relevant life, world, or weather events that would cause communication about the content with context and/or generate new banners, images, coupons, discounts, or promotions. The artificial intelligence may utilize the new banners, images, coupons, discounts, or promotions and enrich them with context and automatically use them in a smart campaign.

In further exemplary embodiments, the artificial intelligence may calculate a plurality of revenues generated by sending a plurality of different messages to different audiences over a plurality of predefined time intervals and determine content, context and event data to maximize revenue.

In various embodiments, methods and corresponding systems for providing a smart campaign that can be fully powered by various autopilot features. According to various embodiments, the method and systems of the present technology remove the manual effort and redundancy of deciding and configuring the audience and specific visual presentation across several campaigns in order to execute a dynamically personalized and more robust electronic communication strategy. The smart campaign with autopilot (also referred to herein as the autopilot smart campaign, or smart campaign for short) can also eliminate the constraint which caused selecting only a subset of potential categories to segment on, due to inherent time/resource limitations introduced by the workflow for known systems.

One example method for communication via electronic messaging comprises automatically creating an electronic communication personalized for each of a plurality of individual customers of a client, including: dynamic configuring the electronic communication for each of a plurality of individual customers into a single campaign for the client to optimize both relevancy for each of a plurality of individual customers and desired business outcomes for the client. In various embodiments, the dynamic configuring includes decision-making using a business context. The automatic aspects and dynamic configuring can achieve a state of autopilot such that marketing strategies for electronic communication can effectively run on autopilot, according to various embodiments. In some embodiments, a user context and/or an external context may also be used. In various embodiments, a machine learning model is trained and utilized for various aspects of the decision making.

### BRIEF DESCRIPTION OF THE FIGURES

FIG. 1 is a simplified flow diagram of an example process according to various embodiments.

FIG. 2 shows an example communication as the resultant final output of the personalized message created using the process in the example in FIG. 1.

FIG. 3 is a simplified block diagram of a computing system, according to some embodiments.

FIG. 4 shows an exemplary large language model.

FIG. 5 shows an exemplary deep neural network.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A”, and “A and B”, unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computing device (e.g., a desktop computer, a tablet computer, a laptop computer, or other computing device). The methods disclosed herein can also be implemented by a computing system implemented as a cloud-based computing environment, such as a virtual machine or container operating within a computing cloud.

In general, an entity may wish to conduct an organized course of action to promote and sell a product or service, which may be referred to as a campaign. The entity may be a business or an individual. Traditionally, the entity may desire that the campaign include electronic communications to certain intended recipients, including customers or potential customers. The entity may determine the recipients and visual presentation of an electronic communication by defining specific behavior and/or customer criteria as well as products, content and/or offers that should be shown to the recipients of the campaign. The business entity conventionally does this by manually combining these elements together through an audience, electronic communication template of some kind, and assigned ‘recipe rules.’ A ‘recipe rule’ can define a specific strategy for dynamically populating products (e.g., best-selling products from the last seven days from the same category of the product a customer abandoned in their cart). The entity would then be constrained to apply this specific “recipe-rule” and electronic communication template configuration for all recipients, or to alternatively, duplicate the process for each recipient in order to further segment this audience to execute more granular personalization strategies. Examples of campaigns with their audiences, templates for the electronic communication, and associated products, are shown below:

### 1. Example Campaign (Requires 1 Campaign)

Audience: Customers who browsed in the last 30 days and did not purchase
Template: Branded content with sitewide 20% off promotion (promo)
Products: Best-selling products from the last 7 days from the same category of the last product the customer browsed.

### 2. Example Campaign with Basic Discount Preference Segmentation (Requires 2 Campaigns)

Audience 1: Customers who browsed in the last 30 days and did not purchase and have a strong discount preference
Template 1: Branded content with sitewide 20% off promo
Products 1: Best-selling products from the last 7 days from the same category of the last product the customer browsed.
Audience 2: Customers who browsed in the last 30 days and did not purchase and have no discount preference
Template 2: Branded content without a promo
Products 2: Best-selling products from the last 7 days from the same category of the last product the customer browsed.

### 3. Example Campaign with Category Affinity Segmentation (Requires n Campaigns)

Audience 1: Customers who browsed in the last 30 days and did not purchase and have a strong affinity for Category A
Template 1: Category A content
Products 1: Best-selling products from the last 7 days from Category A
Audience 2: Customers who browsed in the last 30 days and did not purchase and have a strong affinity for Category B
Template 2: Category B content
Products 2: Best-selling products from the last 7 days from Category B
Audience 3: Customers who browsed in the last 30 days and did not purchase and have a strong affinity for Category C
Template 3: Category C content
Products 3: Best-selling products from the last 7 days from Category C
Audience n: Customers who browsed in the last 30 days and did not purchase and have a strong affinity for Category N
Template n: Category N content
Products n: Best-selling products from the last 7 days from Category N

Method and systems according to various embodiments can remove the manual effort and redundancy involved with deciding and configuring the audience and specific visual presentation across several campaigns in order to execute a personalized electronic communication strategy. Various embodiments can also eliminate the constraint which caused selecting only a subset of potential categories to segment on, due to inherent time/resource limitations introduced by the workflow for known systems.

In various embodiments, the present smart campaign technology provides an autonomous decision-making product that dynamically creates an electronic communication that is personalized for each individual customer through the configuration of a single campaign for a client. The automatic aspects and dynamic configuring can achieve a state of autopilot such that marketing strategies for electronic communication can effectively run on autopilot, according to various embodiments. The autopilot aspect can provide personalized features in a dynamically configured way. The personalized features include but are not limited to one or more personalized recommendations, personalized content, personalized offers, or a combination of these. The electronic communication may be, for example, an email message, text message, or other type of electronic message suitable for practicing various embodiments. The communication may be for marketing purposes (a marketing communication) or other purposes consistent with this specification.

The system can be aware of the customer's situation and the desired business outcome(s) of the client in order to determine the right “reason” to send the electronic communication. In this context, the term “reason” can be associated with a coherent message that is communicated to a customer through a combination of product recommendations, content and/or offer(s). For example, one “reason” to send a customer an electronic communication might be to inform them about products that the customer cares about which have recently been discounted; in order to achieve a particular business outcome (e.g., driving a second purchase, etc.). In this example regarding driving a second purchase, the “situation” of the customer can be that of being a one-time buyer with a known preference toward a specific set of products. The desired business outcome in this particular example is to maximize the likelihood of converting one-time buyers into repeat buyers. This is just one example of the reasons to send an electronic communication, others are described elsewhere herein.

In various embodiments, there are three distinct categories of information processed through the decision-making process, which includes continuously learning by leveraging historical data and the outcomes of the decisions made, in order to maximize the likelihood of achieving the desired business outcome which is at least based on at least a business context. User context and/or external context may also be considered in some embodiments.

For the continuous learning aspect, a machine learning/AI model may be included in the decision-making process. In various embodiments, for the decision-making process, historical data and decision outcomes can be leveraged, at least in part, by having the machine learning/AI model trained on historical data as well the outcomes of the decisions made. Examples of historical data include a customer's historical response to offers, or what that customer bought in what size/color, to name just few examples. Other historical data that is available may be used. In various embodiments, the model continuously learns based, at least in part, on observing and leveraging the outcome of decisions the model decided to take in the smart campaign. For example, the smart campaign may have decided to show a customer a blue shoe, and depending on whether the customer interacts with that showing of the blue shoe can inform the model of the customer's preference. The model can learn based on those interactions and preferences and apply that learning to future decision making. In some embodiments, the outcome of decisions for prior campaigns involving the same or similar customers, and/or the same or similar products, may also be utilized.

In various embodiments, at least the business context may be considered/used for automatically and dynamically configuring a campaign. In some embodiments, a user context or an external context may also be used for a particular campaign in addition to the business context, or a combination of the user context and the external context along with the business context. Some non-limiting examples of these contexts are as follows:
(i) Business Context. This category can include understanding specific business performance goals and maximizing the likelihood of achieving performance goals such as overall or category-specific revenue growth, merchandising sell-thru rates, converting one-time buyers to repeat buyers, etc.
(ii) User Context. This category includes behavioral data such as electronic communication opens/views/clicks, on-site and instore interactions and purchases, etc. The behavioral data can also include derived data points such as predicted lifetime value, buyer lifecycle stage, category affinity, etc., and general data like age, geo-location, etc. The value can be in terms of engagement (which can include, but is not limited to value in terms of clicks, purchases or revenue).
(iii) External Context. This category includes understanding when events such as weather, physical store location, sporting event outcomes, and/or other external events such as a pandemic can have an effect on a customer and in turn, information regarding the external context may be used to increase the relevancy of a message. For example, it can be relevant to recommend cold weather apparel for customers experiencing snowy weather or to include an in-store promotional offer for a customer that lives nearby a physical store location. If the external context affects the ability of customers to visit a physical store location, the offer can be adjusted accordingly, e.g., to focus on online purchaser opportunities and offers; to alert customers in a particular area when a physical store location is open again for business and ready for customers to come back.

The business context, with or without one or more of the other contexts, can then contribute to personalization in deciding the best combination of message elements, including but not limited to, products, content and offers to show to a given customer when rendering an electronic communication in the electronic communication engine. The resulting electronic communication for each customer is personalized and intended to maximize both customer relevancy and desired business outcomes.

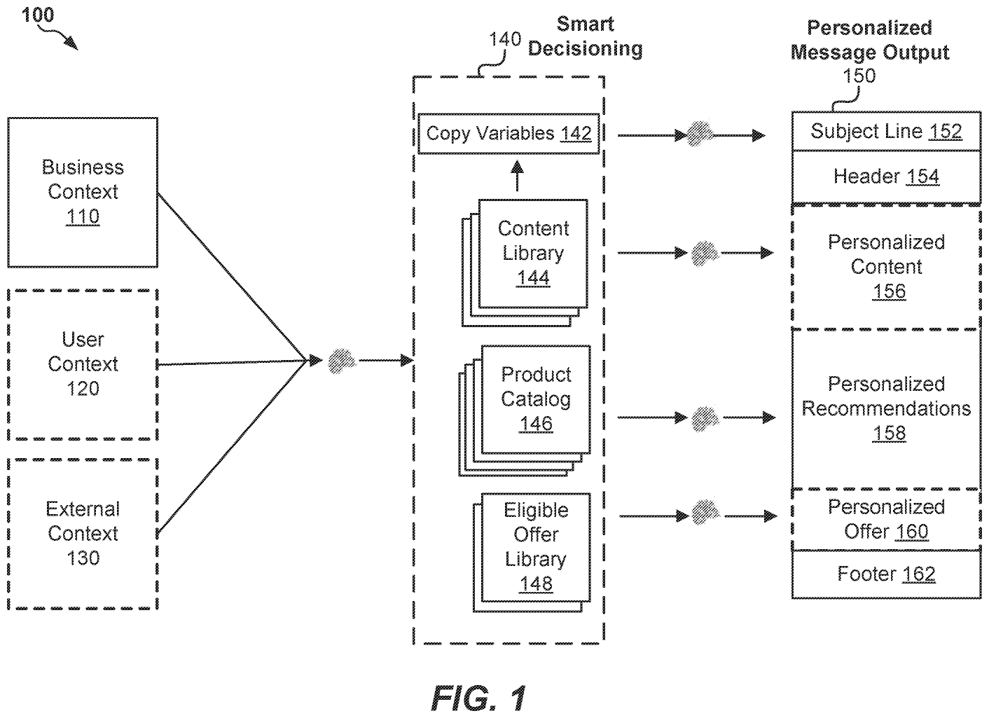

FIG. 1 is a simplified flow diagram of the example process 100 according to various embodiments. In this example, at least the business context 110 (and optionally the user context 120 and/or external context) can be considered in the Smart Decisioning block 140. In block 140 in this example, there are three libraries—a content library 144, a product catalog 146, and an eligible offer library 148. The “brain” symbol as used herein merely indicates that various techniques are being used according to various embodiments of the present technology and also that there can be learning and improving over time. Variables can be copied from some or all of the content library 144, the product catalog 146, and the eligible offer library 148 to a copy variables block 142.

The content library 144 can include content that the client indicates as eligible to show to customers/potential customers. The method in some embodiments can look at the content to determine if it makes sense to show it to particular customers/potential customers.

The product catalog 146 can include, for a “shoe” example, the kind of styles of shoes that is determined to make the most sense to show this customer/potential customer. For this shoe example, the method may look at the price point for the shoe, a certain color, a certain style, etc. for the customer/potential customer.

The eligible offer library 148 can include the types of offers that the client is willing to provide to customers or potential customers. The types of offers may include, for example, free shipping, 10% off, buy a pair of shoes and get a free pair of socks, to name a few types. Other types of offers may be used. In various embodiments, the method determines if it makes sense to give the particular offer or to select from a set of offers to give to this customer/potential customer.

One of the aims of various embodiments is to pull together a cohesive message that is relevant to the customer/potential customer, while also satisfying the business goals the client aims to achieve.

In some embodiments, a decision may be determined that there is no content to show a particular customer/potential customer and no offer to show this customer/potential customer, so the focus may then be the showing of product information from the product catalog to that customer/potential customer. It also may occur that a decision is made that there are two pieces of content and two offers that can be given, for example. In various embodiments, one of the business goals is to choose the lowest value offer of the available offers in order to get the maximum margin.

FIG. 1 also illustrates outputs of the smart decisioning block 140 being used by various embodiments to generate a personalized message output 150 for the electronic communication. The personalized message output 150 can include at least a subject line 152, a header 154, one or more personalized recommendations 158, and a footer 162. In some embodiments, the personalized message output 150 can also include a personalized content 156 and a personalized offer 160. In various embodiments, the subject line 152 can be dynamically determined based on product/category preference for the particular customer, as a function of the smart decisioning block 140. Personalized recommendations 158 can be dynamically chosen based on the user context including for example personal product preference, as a function of the smart decisioning block 140.

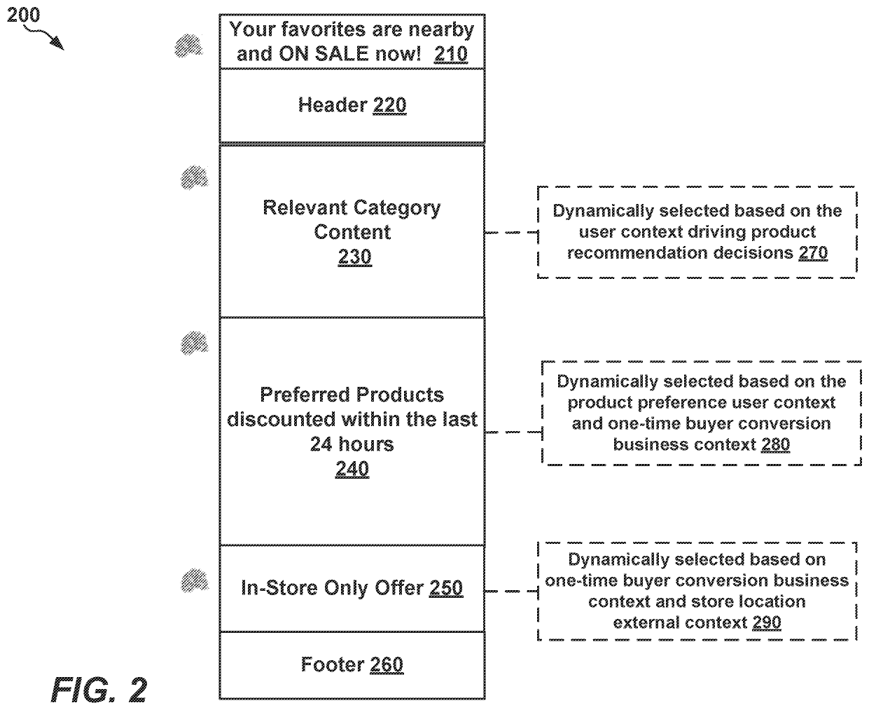

FIG. 2 provides an illustrative example 200 of the personalized message output 150 for an electronic communication. In the example in FIG. 2, the subject line 152 in FIG. 1 is the subject line “Your favorites are nearby and ON SALE now!”. The header 154 in FIG. 1 is the header 220 in the example embodiment in FIG. 2. The example in FIG. 2 includes example embodiments of the personalized recommendations 158 in FIG. 1 in the form of “Preferred Products discounted with the last 24 hours” at 240. This personalized recommendation may be dynamically selected based on the product preference user context and one-time buyer conversion context 280.

In FIG. 2, the personalized message output may also include an example embodiment 230 (“Relevant Category Content”) of the personalized content 156 in FIG. 1. The “Relevant Category Content” portion in FIG. 2 in the electronic communication can be dynamically selected based on the user context driving product recommendation decisions in block 270 (e.g., based on “User Context”, see FIG. 1).

In FIG. 2, the personalized message output may also include an example embodiment 250 (“In-Store Only Offer”) of the personalized offer 160 in FIG. 1. The “In-Store Only Offer” 250 portion of the electronic communication may be dynamically selected based on one-time buyer conversion business context and store location external context in block 290 (e.g., based on embodiments of both the “Business Context” 110 and the “External Context” 130 in FIG. 1 in this example.

Thus, FIG. 2 illustrates just one example and includes an example at 240 of the personalized recommendations 158 of FIG. 1 plus an example at 230 of the optional personalized context 156 of FIG. 1 and an example at 250 of the optional personalized offer 160 of FIG. 1. As described above, the personalized content 156 and personalized offer 160 may one or both be optionally included in addition to the personalized recommendations 158.

The electronic communication may include, for example, an email message, text message, or other type of electronic message suitable for practicing various embodiments. The communication may be for marketing purposes (a marketing communication) or other purposes consistent with this specification.

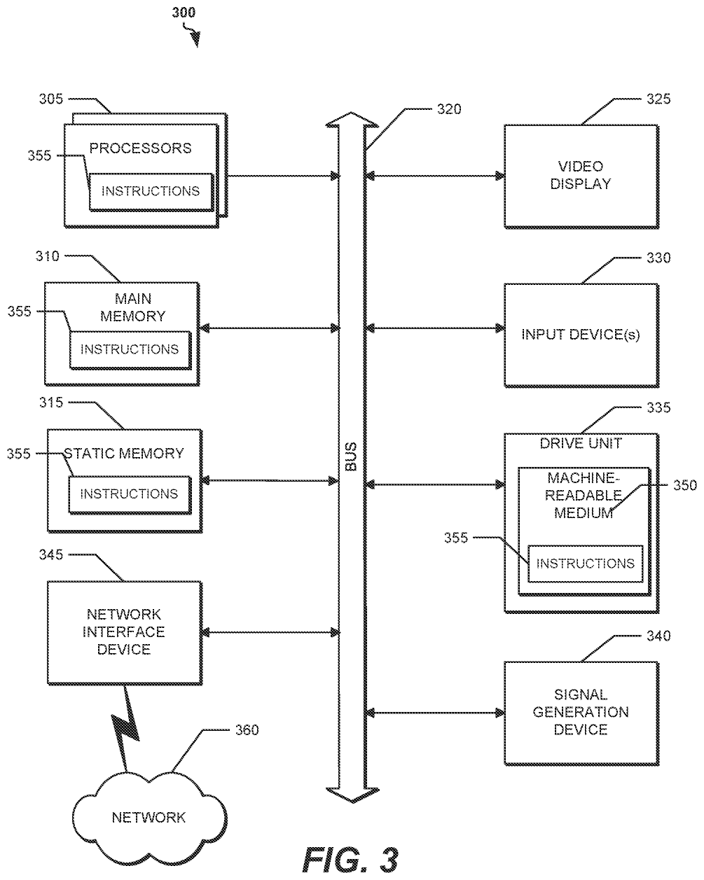

FIG. 3 shows a diagrammatic representation of a computing device for a machine in an example electronic form of a computer system 300, within which a set of instructions for causing the machine to perform any one or more of the methods discussed herein can be executed. In example embodiments, the machine operates as a standalone device, or it can be operatively connected or networked to other machines. In a networked deployment, the machine can operate in the capacity of a server, a client machine in a server-client network environment, or as a peer machine in a peer-to-peer (or distributed) network environment. The machine can be a server, desktop personal computer (PC), laptop PC or any machine capable of executing a set of instructions that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 300 includes a processor or multiple processors 305 (e.g., a central processing units (CPU), a graphics processing unit (GPU), or both), a main memory 310, and a static memory 315, which communicate with each other via a bus 320. Computer system 300 can further include a video display 325 (e.g., an LCD, projector). Computer system 300 also includes at least one input device 330, such as an alphanumeric input device (e.g., a keyboard, keypad, remote control, graphical user interface, etc.), a cursor control device (e.g., a mouse), a microphone, a digital camera, a video camera, and so forth. Computer system 300 also includes a disk drive unit 335, a signal generation device 340 (e.g., a speaker), and a network interface device 345.

Drive unit 335 (also referred to as the disk drive unit 335) includes a machine-readable medium 350 (also referred to as a computer-readable medium 350), which stores one or more sets of instructions and data structures (e.g., instructions 355) embodying or utilized by any one or more of the methodologies or functions described herein. Instructions 355 can also reside, completely or at least partially, within the main memory 310 and/or the processors 305 during execution thereof by computer system 300. Main memory 310 and processors 305 also constitute machine-readable media.

Instructions 355 can further be transmitted or received over a communications network 360 via network interface device 345 utilizing one or more transfer protocols (e.g., Hyper Text Transfer Protocol (HTTP), Serial, and Modbus). Communications network 360 includes the Internet, television network, local intranet, Personal Area Network (PAN), Local Area Network (LAN), Wide Area Network (WAN), Metropolitan Area Network (MAN), virtual private network (VPN), storage area network (SAN), frame relay connection, Advanced Intelligent Network (AIN) connection, synchronous optical network (SONET) connection, Digital Data Service (DDS) connection, Digital Subscriber Line (DSL) connection, Ethernet connection, Integrated Services Digital Network (ISDN) line, cable modem, Asynchronous Transfer Mode (ATM) connection, or a Fiber Distributed Data Interface (FDDI) or Copper Distributed Data Interface (CDDI) connection. Furthermore, communications also includes links to any of a variety of wireless networks including Wireless Application Protocol (WAP), General Packet Radio Service (GPRS), Global System for Mobile Communication (GSM), Code Division Multiple Access (CDMA) or Time Division Multiple Access (TDMA), cellular phone networks, Global Positioning System (GPS), cellular digital packet data (CDPD), Research in Motion, Limited (RIM) duplex paging network, Bluetooth radio, or an IEEE 802.11-based radio frequency network.

While machine-readable medium 350 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, RAM, ROM, and the like.

In some embodiments, the computing system 1300 may be implemented as a cloud-based computing environment, such as a virtual machine operating within a computing cloud. In other embodiments, the computing system 1300 may itself include a cloud-based computing environment, where the functionalities of the computing system 1300 are executed in a distributed fashion. Thus, the computing system 1300, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 1300, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, PYTHON, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

For purposes of discussion, Artificial Intelligence (“AI”) may encompass Machine Learning (“ML”), Generative Artificial Intelligence (“GAI”), Large Language Models (“LLMs”), Reinforcement Learning (“RL”), Neural Networks (“NNs”), Deep Neural Networks (“DNNs”), Simulated Neural Networks (“SNNs”) and/or Artificial Neural Networks (“ANNs”).

The AI used herein may be either off-the-shelf pre-trained AI, e.g., ChatGPT-4, or could be further trained in-house using proprietary data or collected data to better perform the specific tasks or could be trained from scratch in-house using proprietary or collected data for desired tasks. In other words, the AI may be preexisting, preexisting with custom in-house modifications and/or completely built from the ground-up in-house.

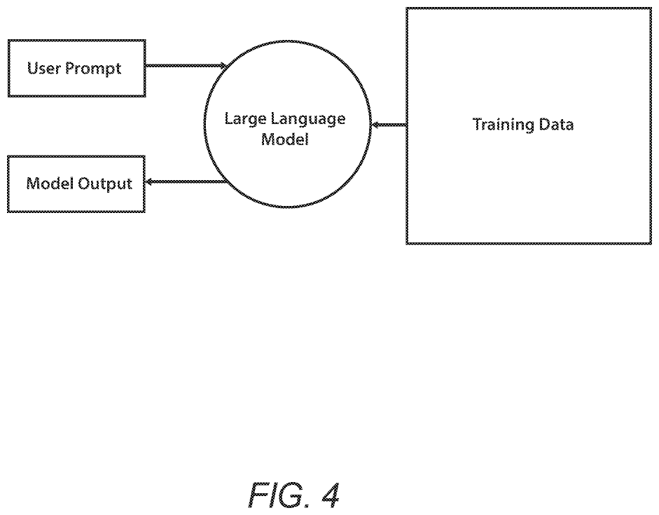

FIG. 4 shows an exemplary large language model.

Shown in FIG. 4 is a user prompt, a large language model, training data, and a model output.

A user prompt in a large language model (LLM) is a piece of text that is used to guide the LLM to generate a desired model output. The prompt can be used to specify the type of model output that the LLM should generate, as well as the style and tone of the output.

The quality of the model output generated by an LLM is heavily influenced by the quality of the prompt. A well-crafted prompt will help the LLM to generate output that is more relevant, accurate, and creative.

A LLM is a type of artificial intelligence (AI) model that is trained on a massive amount of text data. This data can be text from books, articles, websites, or any other source of text. The LLM learns the patterns and structure of the text data, and it can then use this knowledge to generate new text, translate languages, write different kinds of creative content, and answer questions in an informative way.

LLMs are advanced artificial intelligence algorithms trained on massive amounts of text data for the purposes of content generation, summarization, translation, classification, sentiment analysis and so much more. Smaller datasets are composed of tens of millions of parameters, while larger sets extend into hundreds of billions of data points. Depending on the purpose of the LLM, the training data will vary.

Example datasets and what their purposes include:

Social media posts: Publicly available social posts can be used to train the model to understand informal language, slang, and online trends, as well as to identify sentiment.

Academic papers: Scholarly articles can be used to understand terminology and technical language, as well as to extract key information.

Web pages: Publicly available web sites can be used to understand writing styles or increase the range of topics a large language model can understand.

Wikipedia: Because of the vast knowledge that Wikipedia houses, this can be used to increase the range of topics a large language model can understand.

Books: Books of various genres can be used to understand different writing styles, storyline development, and narrative structures.

Using the above examples, if an LLM is trained on social media posts and books, it becomes easier for the model to produce text in a human-like fashion because it has a clear understanding of formal and informal language. The answers it produces is highly dependent on the training data used.

Transformer architecture is the backbone of LLMs. The transformer architecture is a neural network architecture that allows for parallel processing and is used by large language models to process data and generate contextually relevant responses. It consists of a series of layers, with each layer consisting of parallel processing components called attention mechanisms and feedforward networks. The attention mechanisms weigh the importance of each word, using statistical models to learn the relationships between words and their meanings. This allows LLMs to process sequences in parallel and generate contextually relevant responses.

Large language models can process and understand human language at scale. These models use deep learning techniques to analyze vast amounts of text data, making them highly proficient in language processing tasks such as text generation, summarization, translation, and sentiment analysis.

Artificial neural networks (ANN) first learn from training data and then are later used to make logical inferences from new input data. An input data vector is provided with training data during training sessions and then with new input data when the artificial neural network is used to make inferences. The input data vector is processed with weight data stored in a weighted matrix to create an output data vector.

After processing the input data vector with the weighted matrix, the system creates the output data vector. The output data vector may be combined with an output function to create a final output for the artificial neural network. The output function may be referred to as an activation function. During training sessions, the output data may be compared with a desired target output and the difference between the output data and the desired target output may be used to adjust the weight data within the weight matrix to improve the accuracy of the artificial neural network.

Artificial neural networks may comprise many layers of weight matrices such that very complex computational analysis of the input data may be performed. Artificial intelligence relies upon large amounts of very computationally intensive matrix operations to initially learn using training data to adjust the weights in the weight matrices. Later, those adjusted weight matrices are used to perform complex matrix computations with a set of new input data to draw inferences upon the new input data.

LLMs and neural networks can be combined to work together. In some exemplary embodiments, this may be done by using the LLM to generate a set of features that are then fed into the neural network. The neural network can then use these features to make predictions or classifications. For example, in natural language processing, LLMs can be used to generate text features that are then fed into neural networks for tasks such as sentiment analysis, machine translation, and question answering. In computer vision, LLMs can be used to generate image features that are then fed into neural networks for tasks such as object detection, image classification, and scene understanding.

The training of AI includes:

Supervised learning: In supervised learning, the AI is trained on a set of labeled data.

Unsupervised learning: In unsupervised learning, the AI is trained on a set of unlabeled data.

Reinforcement learning: In reinforcement learning, the AI is rewarded for identifying an item correctly. Over time, the AI consistently improves.

The specific approach that is used will depend on the specific needs of the application. For example, if the goal is to identify changes as soon as possible, then supervised learning may be a good option. However, if the goal is to understand the nuances of an item, then unsupervised learning or reinforcement learning may be a better option.

In addition to the type of learning, the training of AI also depends on the size and quality of the data set. A larger data set will typically lead to better performance, but it may also take longer to train the AI. The quality of the data set is also important, as it should be representative of the types of documents that the AI will be used to analyze.

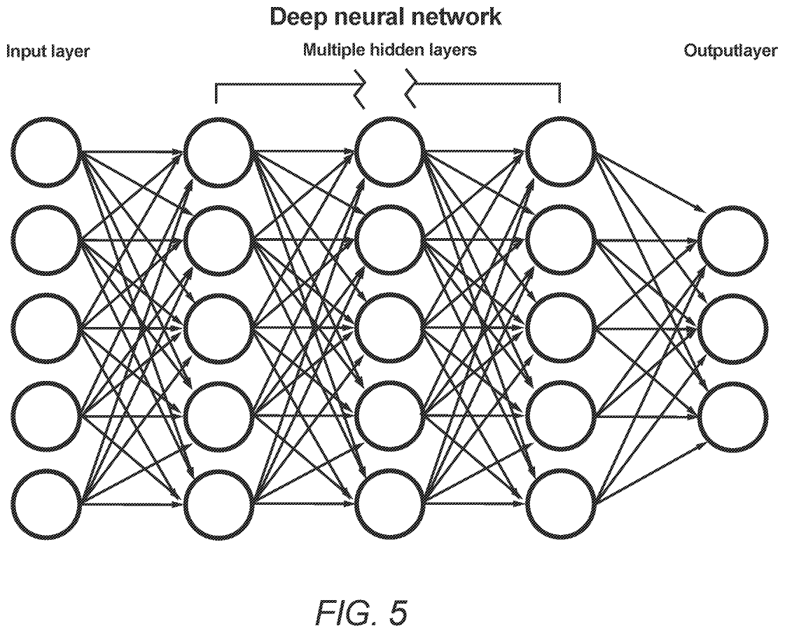

FIG. 5 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of a node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

Most deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input—output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are commonly used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

With respect to FIG. 5, according to exemplary embodiments, the system produces an output, which in turn produces an outcome, which in turn produces an input. In some embodiments, the output may become the input.

While examples below are written in the lens of an individual audience/message, the idea is that with AI it is possible to generate a multitude of reasons to communicate along with the right messaging at any given time.

### Example One

Collecting a set of network data relevant to a smart campaign with autopilot features may include scraping websites for content, receiving data through a feed, a data warehouse or from a database.

Applying one or more transformations to the collected set of data to create a modified set of data may include adding context to the content and reformatting it.

Transformations may also include adding events (life/weather/world) related to the content with context.

Enriched network data may include data having content, context and event data. Expanding the enriched network data may include adding context related to shopper information (for example spend history, visit history, demographics, location, etc.) and/or expanding that context with context related to a goal (for example increasing repurchase rates or promoting an upcoming sale etc.).

Using the enriched network data to deploy a personalized campaign by identifying an audience, time, channel, content and goal of the communication may include identifying the audience to reach out to that is either affected or would be interested by this material, where an audience can be made up of a shopper or set of shoppers and a list is inclusive of all shoppers across many audiences therefore a full list send would require the unique series of decisions described for each audience within the list. The increased breadth and depth of content and context goes beyond the capability of a human and/or existing technical solution and would increase the unique permutations of campaign variations in an existing smart campaign by an order of magnitude. Deciding when to send the message may include the day of a sale, a birthday and/or a weather event, etc.

Generating a message to send may include personalizing each of the following to the shopper by:
i. Generating recommendations related to context.
ii. Biasing recommendations towards context.
iii. Generating copy related to context.
iv. Including promos/discounts related to context.
v. Including originally scraped or AI composed images.

Send the per-shopper personalized messages to the members of the audience.

Measure performance of the messages/campaigns.

Scraping may include:

Use AI to constantly scrape and monitor a retailer's website for new banners, hero images, coupons, discounts and/or promotions.

Enriching may include using AI to enrich the content with context.

The final product could be used for a marketer to include in a campaign or to be automatically pulled into a campaign.

Metrics may include measuring the performance of the resultant campaign and therefore the efficacy of the content and/or strategy.

### Example Two

The artificial intelligence may be used to constantly scrape/monitor a retailer's web site for how the retailer's merchandising/site-management team categorizes content and what categories and/or products they are currently promoting, or what upcoming promos on categories or products are planned. By pulling these products, categories, product-category combinations, AI may be used to enrich them with context and make them available for a marketer to include in a campaign either for personalization or to use them as seeds for shopper affinity audiences.

For scraped content including promos/discounts/banners/categories/products, AI may be leveraged to adapt this content for each specific channel, e.g., SMS (only include the text by layering the text on top of the product images).

For scraped content including promos/discounts/banners/categories/products, AI may be leveraged to extend the content with context, such as product/category description or summary, relevant life/world/weather events, etc., that would drive communicating about this content or recommending this content.

For scraped content including promos/discounts/banners/categories/products, AI may be leveraged to extend the content with context.

All this content, original and AI enriched, becomes available for the Smart Campaigns with Autopilot AI to leverage to automatically generate campaign strategies and to incorporate into campaign creative, copy and recommendations. Further they also become available to the marketer to include in campaigns they build and deploy. For example, the categories/products can automatically be featured in smart campaigns. Additionally, the products/categories may be prominently featured in campaign recommendations and content broadly, beyond smart campaigns. This AI scraped and generated content could also be used by the Smart Campaigns AI to identify which shoppers to target based on interest in the promoted products/categories with the goal of maximizing the efficacy of the resultant campaign.

### Example Three

The clients' websites may be scraped continuously for upcoming promotions along with coupons and/or discounts and the creative may be used to promote the promotion, e.g., Acme Annual Fall Sale. AI may be used to understand the scraped info including promo start/end, discount amount, coupon code, which creative is linked to the promo, if there is no creative linked to the promo then the context of the promo may be used. Enabling AI to generate required creative, e.g., images, copy, banners, etc. and then create relevant campaigns to run leading up and during the promo with a message that highlights the promotion, has a countdown to when the promo starts (or ends), shares the coupon/discount related to the promo, including the creative related to the promo (e.g., Acme logo with fall colors).

Scraping the Internet for the weather forecast for severe weather events, scraping the client website for product information and enriching it with AI with context as to which weather events they relate (For example, rain with raincoats). If a weather event is happening in a given area, target shoppers in that area with messaging that includes recommended products that are relevant in the context of the weather event. Include in the messaging, creative or copy that is AI generated relating to the weather event. Can also replace weather with sports teams.

Exemplary embodiments can also scrape a retailer's web site to understand how they categorize and group their products into themes (e.g., by sport type, or by team, or by season, or by brand, or by event, etc.). Exemplary embodiments can also capture these groupings along with what products fall under them and any creative and copy related to them. AI can be used to reformat, compose, generate unique creative relevant to these categories, and the AI can identify who would be interested in each of the different categories and send them personalized messages with the AI generated context.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method of using artificial intelligence for automatically collecting and enriching network data for a smart campaign with autopilot features, the method comprising:
collecting a set of network data relevant to a smart campaign with autopilot features;
applying one or more transformations to the collected set of data to create a modified set of data;
generating from the modified set of data, enriched network data for a smart campaign with autopilot features, the enriched network data having content, context and event data; and
using the enriched data to deploy a personalized campaign by identifying an audience, time, channel, content and goal of a communication.

2. The computer-implemented method of claim 1, the collecting further comprising: scraping a website or receiving data through a feed, data warehouse or from a database.

3. The computer-implemented method of claim 1, further comprising:
the artificial intelligence applying one or more transformations to the collected set of data to create the modified set of data, including adding context to the collected set of data.

4. The computer-implemented method of claim 1, further comprising:
the artificial intelligence applying one or more transformations to the collected set of data to create the modified set of data, including adding collected event information.

5. The computer-implemented method of claim 1, further comprising:
the artificial intelligence using the content, the context and the event information to identify who would be interested in the content, the context and the event information.

6. The computer-implemented method of claim 1, further comprising:
the artificial intelligence automatically determining when to send a message.

7. The computer-implemented method of claim 1, further comprising:
the artificial intelligence generating in a message a recommendation related to the enriched content.

8. The computer-implemented method of claim 1, further comprising:
the artificial intelligence biasing in a message a recommendation towards context.

9. The computer-implemented method of claim 1, further comprising:
the artificial intelligence generating message copy related to the context.

10. The computer-implemented method of claim 1, further comprising:
the artificial intelligence including in a message a promotion or a discount related to the context.

11. The computer-implemented method of claim 1, further comprising:
the artificial intelligence including in a message an originally scraped image or an AI composed image related to content or context.

12. The computer-implemented method of claim 1, further comprising:
the artificial intelligence measuring performance of a message or a campaign of messages.

13. The computer-implemented method of claim 1, further comprising:
the collected set of network data relevant to a smart campaign with autopilot features including: content, context, event data, retailers' websites including new banners, hero images, coupons, discounts, promotions, how retailers' websites merchandising/site management team categorizes content, categories and/or products currently being promoted, upcoming promotions on categories or products, product-category combinations, shopper demographic, shopper preferences, shopper state, weather forecasts, severe weather events, product information, sports teams, and themes.

14. The computer-implemented method of claim 1, further comprising:
the artificial intelligence constantly scraping and monitoring a retailer's website for new banners, images, coupons, discounts, or promotions.

15. The computer-implemented method of claim 14, further comprising:
the artificial intelligence downloading the new banners, images, coupons, discounts, or promotions and enriching them with context and automatically using them in a campaign.

16. The computer-implemented method of claim 1, further comprising:
the artificial intelligence constantly scraping and monitoring a retailer's website for how the retailer categorizes content and what categories and/or products that are currently being promoted.

17. The computer-implemented method of claim 1, further comprising:
the artificial intelligence enriching the content with context.

18. The computer-implemented method of claim 1, further comprising:
the artificial intelligence enriching scraped content with context, including a product or category description.

19. The computer-implemented method of claim 1, further comprising:
the artificial intelligence enriching the content with context, including adding relevant life, world, or weather events that would cause communication about the content with context.

20. The computer-implemented method of claim 1, further comprising:
the artificial intelligence generating based on collected content and context, new banners, images, coupons, discounts, or promotions.

21. The computer-implemented method of claim 20, further comprising:
the artificial intelligence utilizing the new banners, images, coupons, discounts, or promotions and enriching them with context and automatically using them in a smart campaign.

22. The computer-implemented method of claim 1, further comprising:
calculating a plurality of revenues generated by sending a plurality of different messages to different audiences over a plurality of predefined time intervals.

23. The computer-implemented method of claim 22, further comprising:
using artificial intelligence to determine content, context and event data to achieve a goal.

24. The computer-implemented method of claim 23, further comprising:
the goal being maximum revenue or profit.
